(19) United States
(12) Patent Application Publication
(10) Pub. No.: US 2007/0243433 A1
(43) Pub. Date: Oct. 18, 2007

(54) Reformer with a plurality of heaters and fuel cell system using the same

(76) Inventors: Ju-Yong Kim, Seoul (KR); Sung-Chul Lee, Yongin-si (KR); Jin-Goo Ahn, Yongin-si (KR)

Correspondence Address: Robert E. Bushnell, Suite 300, 1522 K Street, N.W., Washington, DC, 20005, US

(21) Appl. No.: 11/730,524

(22) Filed: Apr. 2, 2007

(30) Foreign Application Priority Data
Apr. 14, 2006 (KR) 10-2006-0034304

(51) Int. Cl. H01M 8/06; B01J 19/00

(52) U.S. Cl. 429/20; 422/198

(57) ABSTRACT

Disclosed are a reformer with a plurality of heaters for precisely controlling the temperature thereof, and a fuel cell system using the same. The fuel cell system is constructed with an electric generator that generates electricity through electrochemical reaction between hydrogen and oxygen, a pump that supply the electric generator with oxygen in the air, a reformer that supplies the electric generator with hydrogen, a water container that supplies the reformer with water, and a fuel container that supplies the reformer with reforming fuel containing hydrogen and inflammable combustion fuel. The reformer in the fuel cell system is constructed with a reforming reaction unit that receives thermal energy and reforms reforming fuel containing hydrogen into hydrogen through a catalyst, a heat source unit that supplies the reforming reaction unit with heat obtained by burning inflammable combustion fuel, and an auxiliary heat source unit that supplies the reforming reaction unit with heat generated from a hot wire using electric energy.

### CLAIM OF PRIORITY

This application makes reference to, incorporates the same herein, and claims all benefits accruing under 35 U.S.C. § 119 from an application for REFORMER WITH DOUBLE HEATER AND FUEL CELL SYSTEM USING THE SAME earlier filed in the Korean Intellectual Property Office on 14 Apr. 2006 and there duly assigned Serial No. 10-2006-0034304.

### BACKGROUND

1. Field of the Invention

The present invention relates to a reformer and a fuel cell system incorporating the reformer, and more particularly, to a reformer with a plurality of heaters for precisely controlling the temperature of the reformer, and a fuel cell system incorporating the reformer.

2. Discussion of the Related Art

In general, a fuel cell is a power generating system that directly transforms chemical energy into electric energy by an electrochemical reaction between hydrogen and oxygen. In order to supply hydrogen to a fuel cell system, pure hydrogen can be directly used, or methanol, ethanol, natural gas or the like materials can be reformed to produce hydrogen to be supplied. Further, in order to supply oxygen to the fuel cell system, pure oxygen can be directly used, or oxygen contained in the air can be supplied by an air pump or the like apparatus.

Meanwhile, the fuel cell is classified as either a polymer electrolyte membrane fuel cell (PEMFC) or a direct methanol fuel cell (DMFC), which operate at room temperature or a temperature of less than 100° C., a phosphoric acid fuel cell (PAFC) which operates at a temperature of 150° C.˜200° C., a molten carbon fuel cell (MCFC) which operates at a temperature of 600° C.˜700° C., a solid oxide fuel cell (SOFC) which operates at a high temperature of more than 1000, and so on. These fuel cells operate on basically the same principles, but they are different in the kind of fuel, catalyst, electrolyte, and other parameters.

Among the fuel cells, the polymer electrolyte membrane fuel cell (PEMFC) uses hydrogen obtained by reforming methanol, ethanol, natural gas, or other fuels, and has advantages when compared with other types of fuel cells because its output performance is excellent, its operation temperature is low, and it starts and responds quickly. Thus, the PEMFC can be widely used as a distributed power source for a house and a public building, a small portable power source for a portable electronic apparatus, as well as a transportable power source for a vehicle.

Basically, the PEMFC is constructed with an electric generator to generate a voltage and a current by electrochemical reaction between hydrogen and oxygen, a reformer to reform the reforming fuel and generate hydrogen, and a fuel container to store the reforming fuel. The electric generator is constructed with at least one unit cell for generating the electric energy. Here, the plurality of unit cells can have a stacked structure.

Further, the reformer is constructed with a reforming reaction unit to produce the reformed gas containing abundant hydrogen by reforming the reforming fuel through reforming reaction, and a combustion reaction unit to supply heat needed for the endothermic reforming reaction. Additionally, the reformer is constructed with a carbon monoxide (CO) remover to remove carbon monoxide from the reformed gas, because carbon monoxide would poison the catalyst of the fuel cell.

Here, the reforming reaction may be a steam reforming (SR) reaction, a preferential oxidation (POX) reaction, or an auto thermal reforming (ATR) reaction, etc. A catalyst used in this reforming reaction contains a Cu/ZnO catalyst or the like catalyst. Such a catalyst is especially vulnerable to heat, so that the efficiency of the catalyst largely varies according to reaction temperature. Therefore, the heat supplied to the reforming reaction unit through the combustion reaction unit should be precisely controlled.

The reaction temperature needed for the reforming reaction, however, is between approximately 500° C. and approximately 700° C., so that the combustion reaction unit burns the combustion fuel having a large heating value in order to supply the needed heat. At this time, when the combustion reaction of the combustion fuel is performed and then stopped to maintain the temperature of the combustion reaction unit constant around the reforming reaction temperature, the temperature gradient becomes steeper because of the large heating value of the combustion fuel. As the temperature gradient becomes steeper, it is difficult to maintain the constant temperature of the combustion reaction unit. Then, the reforming reaction unit receiving heat from the combustion reaction unit cannot maintain the reaction temperature, thereby causing the efficiency of the catalyst to deteriorate. Therefore, the production of hydrogen is reduced, and total efficiency of the fuel cell system is concomitantly lowered.

### SUMMARY OF THE INVENTION

It is therefore an object of the present invention to provide an improved reformer and a fuel cell system incorporating the reformer.

It is another object of the present invention to provide a reformer with a plurality of heaters for precisely controlling the temperature of the reformer, and a fuel cell system incorporating the reformer.

The and other objects of the present invention may be achieved by providing a reformer constructed with a reforming reaction unit that receives thermal energy and reforms reforming fuel, which contains hydrogen, into hydrogen through a catalyst, a heat source that supplies the reforming reaction unit with heat obtained by burning an inflammable combustion fuel, and an auxiliary heat source unit that supplies the reforming reaction unit with the heat generated from a hot wire using electric energy.

According to an aspect of the invention, the reformer is further constructed with a controller to control the amount of the electric energy to be supplied to the hot wire, and a temperature sensor to sense the temperature of the reforming reaction unit. The controller controls the heat source unit to heat the reforming reaction unit when the temperature sensor senses that the temperature of the reforming reaction unit is lower than a proper reforming reaction temperature, and controls the auxiliary heat source unit to heat the reforming reaction unit when the temperature sensor senses that the temperature of the reforming reaction unit is equal to or higher than the proper reforming reaction temperature. The reforming reaction unit employs steam-reforming catalyst reaction, and butane is used as the reforming fuel and the combustion fuel.

According to another aspect of the present invention, a fuel cell system is constructed with an electric generator that generates electricity through an electrochemical reaction between hydrogen and oxygen, a pump that supplies the electric generator with oxygen in the air, a reformer that supplies the electric generator with hydrogen, a water container that supplies the reformer with water, and a fuel container that supplies the reformer with reforming fuel, which contains hydrogen, and an inflammable combustion fuel. The reformer may be constructed with a reforming reaction unit that receives thermal energy and reforms the reforming fuel, which contains hydrogen, into hydrogen through a catalyst, a heat source unit that supplies the reforming reaction unit with heat obtained by burning the inflammable combustion fuel, and an auxiliary heat source unit that supplies the reforming reaction unit with the heat generated from a hot wire using electric energy.

According to still another aspect of the invention, the fuel cell system may use a polymer electrolyte membrane fuel cell system.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view of a fuel cell system using a reformer constructed as an embodiment according to the principles of the present invention; and

FIG. 2 is a graph showing the temperature of a reforming reaction unit with respect to time in the reformer illustrated in FIG. 1.

### DETAILED DESCRIPTION OF THE INVENTION

Hereinafter, preferable embodiments according to embodiments of the present invention will be described with reference to accompanying drawings, wherein like numerals refer to like elements and repetitive descriptions will be avoided as necessary. Further, the shape and the size of the elements shown in the drawings are exaggerated for convenience.

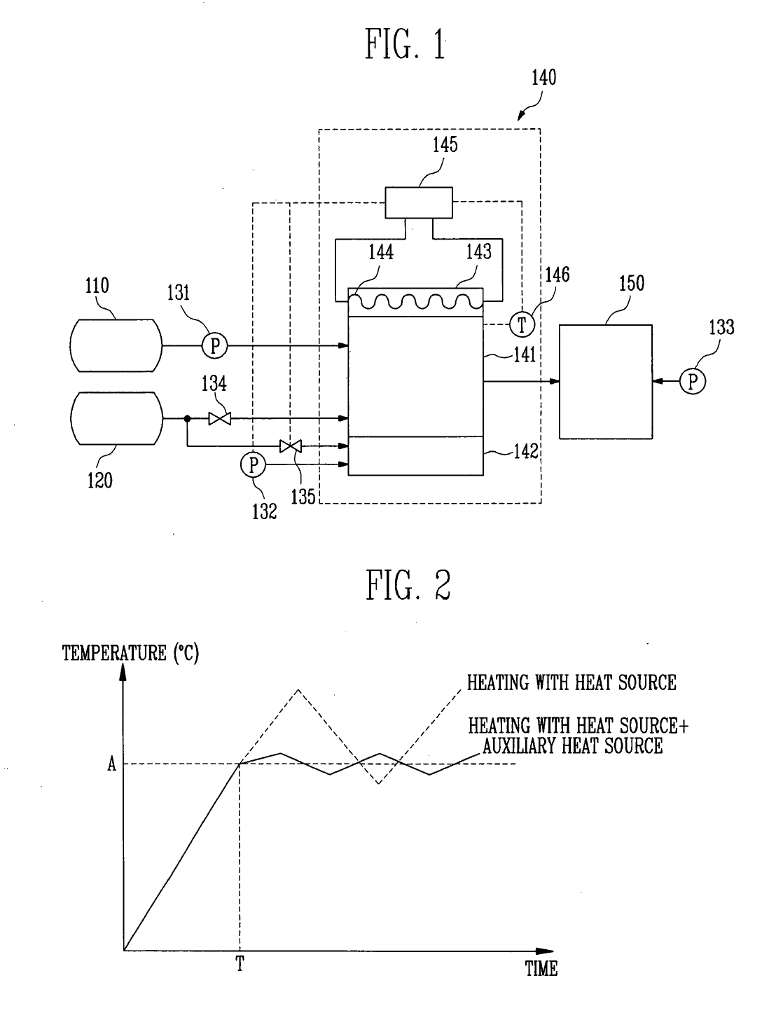

FIG. 1 is a schematic view of a fuel cell system using a reformer constructed as an embodiment according to the principles of the present invention.

In a fuel cell system constructed as an embodiment according to the principles of the present invention, a reforming fuel refers to a fuel that contains hydrogen and is reformed to hydrogen by a reforming reaction. For example, the reforming fuel may be methanol, butane, natural gas, or other fuels. On the other hand, combustion fuel refers to the inflammable fuel that supplies heat, which is generated through the exothermic combustion reaction, for the reforming reaction. For example, the combustion fuel may be natural gas, butane or other fuels. Where butane is used as the reforming fuel and the combustion fuel, when a nozzle of a butane fuel container is opened, gasified fuel is discharged by itself from the fuel container, so that the reforming fuel and the combustion fuel can be supplied without separate fuel supply units. Further, butane advantageously has large combustion heat, so that it is possible to provide sufficient heat needed for the reforming reaction. Hereinafter, for convenience, butane will be used as both the reforming fuel and the combustion fuel. It will be appreciated, however, that the reforming fuel and the combustion fuel are different from each other since the kind of fuel used are different from each other. In this case, the reforming fuel may contain hydrogen, and the combustion fuel may contain an inflammable material having large combustion heat. Meanwhile, an oxidant used in the fuel cell system constructed as an embodiment according to the principles of the present invention can include pure oxygen contained either in a separate storage unit or in the air. Hereinafter, oxygen contained in the air will be used as the oxidant.

Referring to FIG. 1, a fuel cell system constructed as an embodiment according to the principles of the present invention is constructed with a water container 110, a fuel container 120, a reformer 140, an electric generator 150, a first pump 131, a second pump 132, a third pump 133, a first valve 134, and a second valve 135. Further, reformer 140 may be constructed with a reforming reaction unit 141, a heat source unit 142, an auxiliary heat source unit 143, a hot wire 144, a controller 145, and a temperature sensor 146.

The fuel cell system constructed as an embodiment according to the principles of the present invention employs a polymer electrolyte membrane fuel cell, in which reformer 140 generates hydrogen from the reforming fuel and electric generator 150 generates electric energy through an electrochemical reaction between hydrogen and oxygen.

Reforming reaction unit 141 of reformer 140 receives water stored in water container 110 and butane stored in fuel container 120 as the reforming fuel. Water stored in water container 110 is supplied by first pump 131, and the reforming fuel stored in fuel container 120 is supplied by adjusting an opening state of first valve 134. Reforming reaction unit 141 reforms the reforming fuel, which is mixed with water, through a steam-reforming catalyst reaction, thereby generating hydrogen gas. The steam-reforming catalyst reaction can be represented by the following formula 1:
[Reaction Formula 1]
Steam-reforming catalyst reaction:

n-C₄H₁₀+8H₂O→4CO₂+13H₂ . . . H₂₉₈=485.3 KJ/mol

Reforming reaction unit 141 is constructed with temperature sensor 146 to sense the temperature of reforming reaction unit 141.

Reforming reaction unit 141 of reformer 140 is in contact with heat source unit 142 at one side of reforming reaction unit 141. Heat source unit 142 receives oxygen in ambient air as the oxidant, and butane stored in fuel container 130 as the combustion fuel. Oxygen is supplied by second pump 132, and the combustion fuel is supplied by adjusting an opening state of second valve 135. Heat source unit 142 generates heat through a combustion reaction of the combustion fuel, and provides heat to reforming reaction unit 141 contacting heat source unit 142. The combustion reaction of butane can be represented by the following reaction formula 2:
[Reaction Formula 2]
Butane combustion reaction:

n-C₄H₁₀+6.5O₂→4CO₂+5H₂O . . . H₂₉₈=−2658.5 KJ/mol

Reforming reaction unit 141 of reformer 140 is in contact with auxiliary heat source unit 143 at the opposite side of reforming reaction unit 141. Hot wire 144 that transforms electric energy into heat is mounted within auxiliary heat source unit 143. Hot wire 144 can be disposed inside the entirely auxiliary heat source unit 143. Alternatively, hot wire 144 may be selectively disposed inside auxiliary heat source unit 143 at a position corresponding to a position in reaction unit 141 where reforming reaction unit 141 is relatively weakly heated by heat source unit 142. Controller 145 controls the amount of the electric energy supplied to hot wire 144 depending on a signal of temperature sensor 146 provided in reforming reaction unit 141, thereby controlling a heating value of hot wire 144. Further, controller 145 controls second valve 135 and second pump 132 depending on the signal from temperature sensor 146 provided in reforming reaction unit 141.

With this configuration, reformer 140 constructed as an embodiment according to the principles of the present invention operates as follows.

When reformer 140 starts operating, the temperature of reforming reaction unit 141 should be quickly increased, therefore heating source part 142 having a large heating value is used for heating reforming reaction unit 141. In order to heat reforming reaction unit 141, controller 145 controls the opening state of second valve 135 and drives second pump 132 to supply the combustion gas and oxygen to heat source unit 142, and the combustion gas and oxygen are burned in heat source unit 142. Then, heat from heat source unit 142 is transferred to reforming reaction unit 141 such that the temperature of reforming reaction unit 141 increases continuously. Meanwhile, temperature sensor 146 provided in reforming reaction unit 141 continuously senses the temperature of reforming reaction unit 141, and controller 145 receives the signal corresponding to the sensed result. Thus, controller 145 can control the temperature of reforming reaction unit 141 in real time on the basis of the signal from temperature sensor 146.

When the temperature of reforming reaction unit 141 reaches a proper reforming reaction temperature, controller 145 adjusts the opening state of second valve 135 and stops driving second pump 132 to prevent the combustion gas and oxygen from being supplied to heat source unit 142. At the time, controller 145 supplies the electric energy to hot wire 144 of auxiliary heat source unit 143 and makes hot wire 144 generate heat. Here, controller 145 precisely varies the electric energy supplied to hot wire 144 such that the heating value of hot wire 144 is precisely adjusted is correspondence with the varied electric energy. Therefore, controller 145 can precisely control the heat transferred from auxiliary heat source unit 143 to reforming reaction unit 141, thereby maintaining the temperature of reforming reaction unit 141 to have a proper reforming reaction temperature.

FIG. 2 is a graph showing the temperature of a reforming reaction unit with respect to time in the reformer constructed as an embodiment according to the principles of the present invention.

Referring to FIG. 2, after reformer 140 starts operating, reforming reaction unit 141 is heated by heat source unit 142 until the temperature of reforming reaction unit 141 reaches a proper reforming reaction temperature A. After the lapse of time T during which the temperature of reforming reaction unit 141 rises to reforming reaction temperature A, reforming reaction unit 141 is heated by auxiliary heat source unit 143. Auxiliary heat source unit 143 can control the heating value, so that the temperature of reforming reaction unit 141 is maintained around reforming reaction temperature A. On the other hand, if reforming reaction unit 141 is still heated by heat source unit 142 even after the lapse of time T, the large heating value of heat source unit 142 makes it difficult to precisely control the temperature of reforming reaction unit 141 (refer to the dotted line of FIG. 2).

Referring back to FIG. 1, electric generator 150 is constructed with a membrane electrode assembly (MEA) including an anode electrode (not shown), a cathode electrode (not shown) and an electrolyte membrane (not shown) interposed between the anode and cathode electrodes, in which the membrane electrode assembly (MEA) is used as a unit cell. Hydrogen gas produced in reformer 140 is supplied to the anode electrode, and oxygen in the air is supplied to the cathode electrode by third pump 133, so that electricity is generated by the electrochemical reaction occurring in a catalyst of each electrode. Here, oxygen is supplied by third pump 133 to electricity generator 150. In electric generator 150, electrochemical reactions can be represented as the following formulas.
[Reaction Formula 3]

Anode: H₂→2H⁺+2e⁻

Cathode: ½O₂+2H⁺+2e⁻→H₂O

Total: H₂+½O₂→H₂O+electric current+heat

Referring to reaction formula 3, hydrogen is separated into a hydrogen ion and an electron in the anode electrode, and the hydrogen ion produced in the anode electrode moves to the cathode electrode via the electrolyte membrane. The hydrogen ion reacts with oxygen in the cathode electrode, thereby producing water. The electrons produced in the anode electrode move to an external circuit as free energy of the chemical reaction changes.

In the foregoing embodiment, the steam-reforming reaction is used in reforming reaction unit 141 of reformer 100 to produce hydrogen gas, but the present invention is not limited thereto. Alternatively, the hydrogen gas can be produced by preferential oxidation (POX), auto thermal reforming (ATR), etc. In these cases, a proper catalyst temperature of reforming reaction unit 141 to be heated by heat source part 142 and auxiliary heat source part 143 may vary depending on a catalyst temperature of the catalyst used in each reforming reaction.

In the reformer constructed as an embodiment according to the principles of the present invention and the fuel cell system incorporating the reformer, the auxiliary heat source unit with the hot wire using electric energy is employed to precisely maintain the temperature of the reforming reaction unit of the reformer, so that the catalyst of the reforming reaction unit can react efficiently at a proper reforming reaction temperature. Thus, sufficient amount of hydrogen with high purity is produced in the reforming reaction unit, so that the fuel cell system has high efficiency.

Although a few embodiments according to the principles of the present invention have been shown and described, it would be appreciated by those skilled in the art that changes might be made in this embodiment without departing from the principles and spirit of the invention, the scope of which is defined in the claims and their equivalents.

What is claimed is:

1. A reformer, comprising:
a reforming reaction unit that respond to reception of thermal energy by reforming fuel containing hydrogen into hydrogen through a catalyst;
a heat source unit that supplies the reforming reaction unit with heat obtained by burning inflammable combustion fuel; and
an auxiliary heat source unit that supplies the reforming reaction unit with heat generated from a hot wire conducting an electric energy.

2. The reformer according to claim 1, further comprising a controller regulating electric energy to be supplied to the hot wire.

3. The reformer according to claim 2, further comprising a temperature sensor gauging the temperature of the reforming reaction unit.

4. The reformer according to claim 3, comprised of the controller regulating the heat source unit to heat the reforming reaction unit when the temperature sensor senses that the temperature of the reforming reaction unit is lower than a proper reforming reaction temperature, and controlling the auxiliary heat source unit to heat the reforming reaction unit when the temperature sensor senses that the temperature of the reforming reaction unit is equal to or higher than the proper reforming reaction temperature.

5. The reformer according to claim 4, comprised of the reforming reaction unit employing a steam-reforming catalyst reaction.

6. The reformer according to claim 5, comprised of using butane as the reforming fuel and as the combustion fuel.

7. A fuel cell system, comprising:
an electric generator disposed to generate electricity through electrochemical reaction between hydrogen and oxygen;
a pump coupled to supply the electric generator with oxygen drawn from ambient air;
a reformer coupled to supply the electric generator with hydrogen;
a container coupled to supply the reformer with water; and
a fuel container coupled to supply the reformer with reforming fuel containing hydrogen and inflammable combustion fuel, with the reformer comprising:
a reforming reaction unit disposed to receive thermal energy and reform reforming fuel containing hydrogen into hydrogen through a catalyst;
a heat source unit supplying the reforming reaction unit with heat obtained by burning inflammable combustion fuel; and
an auxiliary heat source unit supplying the reforming reaction unit with heat generated from a hot wire using electric energy.

8. The fuel cell system according to claim 7, further comprising a controller regulating the amount of the electric energy to be supplied to the hot wire.

9. The fuel cell system according to claim 8, further comprising a temperature sensor gauging the temperature of the reforming reaction unit.

10. The fuel cell system according to claim 9, comprised of the controller controlling the heat source unit to heat the reforming reaction unit when the temperature sensor senses that the temperature of the reforming reaction unit is lower than a proper reforming reaction temperature, and controlling the auxiliary heat source unit to heat the reforming reaction unit when the temperature sensor senses that the temperature of the reforming reaction unit is equal to or higher than the proper reforming reaction temperature.

11. The fuel cell system according to claim 10, comprised of the reforming reaction unit employing steam-reforming catalyst reaction.

12. The fuel cell system according to claim 11, comprised of the combustion fuel comprising a hydrocarbonaceous material.

13. The fuel cell system according to claim 12, comprised of using butane as the reforming fuel and the combustion fuel.

14. The fuel cell system according to claim 13, comprised of the fuel cell system comprising a polymer electrolyte membrane fuel cell system.

15. The reformer according to claim 1, with the inflammable combustion fuel comprising an inflammable material having large combustion heat.

16. The fuel cell system according to claim 7, with the oxygen being oxygen drawn from ambient air.

17. The fuel cell system according to claim 7, with the oxygen being pure oxygen contained in a separate storage unit.
